(19) United States
(12) Patent Application Publication
(10) Pub. No.: US 2026/0149251 A1
(43) Pub. Date: May 28, 2026

(54) WIRE HARNESS

(71) Applicant: SUMITOMO WIRING SYSTEMS, LTD., Yokkaichi-shi (JP)

(72) Inventors: Kotaro SEKINE, Yokkaichi-shi (JP); Kohei HASHIMOTO, Yokkaichi-shi (JP)

(73) Assignee: SUMITOMO WIRING SYSTEMS, LTD., Yokkaichi-shi (JP)

(21) Appl. No.: 19/386,899

(22) Filed: Nov. 12, 2025

(30) Foreign Application Priority Data
Nov. 27, 2024 (JP) 2024-206367

(51) Int. Cl. H02G 3/34; B60R 16/02; H02G 3/00; H02G 3/04

(52) U.S. Cl. CPC H02G 3/34; B60R 16/0215; H02G 3/0481; H02G 3/263

(57) ABSTRACT

A wire harness, including: an exterior cover that is configured to cover an outer periphery of an electric wire; and a fixing member that is configured to fix the exterior cover to a fixing target, wherein: the exterior cover includes: a first part extending linearly along a first direction; and a second part extending in a second direction that intersects the first direction from an end in the first direction of the first part, and the fixing member includes: an attachment that is configured to be attached to the first part so as to cover an outer periphery of the first part; a fixing portion that is configured to be fixed to the fixing target; and a restricting portion that is configured to be able to come into contact with the second part and to restrict movement of the fixing member by coming into contact with the second part.

### BACKGROUND

The present disclosure relates to a wire harness.

Conventionally, there is a wire harnesses including a cylindrical exterior member configured to cover an outer periphery of an electric wire and a fixing member configured to fix the exterior member to a fixing target (see, for example, JP 2020-102991A). The fixing member has an attachment portion that is attached to the exterior member so as to cover an outer periphery of the exterior member. The attachment portion of the fixing member may be configured so as to be movable in a length direction of the exterior member and to be rotatable in a rotational direction about an axis extending along the length direction of the exterior member in order to absorb a relative positional tolerance between the fixing member and the fixing target.

### SUMMARY

In the wire harness as described above, a position of the fixing member attached to the exterior member in the length direction of the exterior member and an orientation of the exterior member may deviate significantly from a state appropriate for fixation to the fixing target. In this case, an operator needs to set the fixing member in a proper position or a proper orientation before fixing it to the fixing target, which leads to a complicated assembly task of assembling the fixing member attached to the exterior member to the fixing target.

An exemplary aspect of the disclosure provides a wire harness that enables improved assemblability.

A wire harness according to the present disclosure includes an electric wire, a cylindrical exterior member configured to cover an outer periphery of the electric wire, and a fixing member configured to fix the exterior member to a fixing target. The exterior member includes a first part extending linearly along a first direction, and a second part extending in a second direction that intersects the first direction from an end in the first direction of the first part. The fixing member includes an attachment portion configured to be attached to the first part so as to cover an outer periphery of the first part, a fixing portion configured to be fixed to the fixing target, and a restricting portion configured to be able to come into contact with the second part and to restrict movement of the fixing member by coming into contact with the second part.

The wire harness of the present disclosure enables improved assemblability.

### BRIEF DESCRIPTION OF THE DRAWINGS

FIG. 1 is a perspective view partially illustrating a wire harness according to a first embodiment;

FIG. 2 is a plan view of a fixing member according to the first embodiment;

FIG. 3 is a perspective view partially illustrating the wire harness according to the first embodiment; and

FIG. 4 is a side view of the wire harness according to the first embodiment seen from a direction along a central axis L1.

### EMBODIMENTS OF THE DISCLOSURE

### Description of Embodiments of Present Disclosure

First, embodiments of the present disclosure will be listed and described.

### A wire harness according to the present disclosure

includes an electric wire, a cylindrical exterior member configured to cover an outer periphery of the electric wire, and a fixing member configured to fix the exterior member to a fixing target. The exterior member includes a first part extending linearly along a first direction, and a second part extending in a second direction that intersects the first direction from an end in the first direction of the first part. The fixing member includes an attachment portion configured to be attached to the first part so as to cover an outer periphery of the first part, a fixing portion configured to be fixed to the fixing target, and a restricting portion configured to be able to come into contact with the second part and to restrict movement of the fixing member by coming into contact with the second part.

According to this configuration, since the movement of the fixing member is restricted by the restricting portion coming into contact with the second part of the exterior member, it is possible to suppress a significant deviation in the position and orientation of the fixing member. As a result, assemblability is improved when the fixing member is assembled to the fixing target.

[2] In [1] above, the restricting portion may include a first slide restricting portion configured to restrict movement of the fixing member in the first direction by coming into contact with the second part.

According to this configuration, since the movement of the fixing member in the first direction is restricted by the first slide restricting portion coming into contact with the second part of the exterior member in the first direction, it is possible to suppress a significant deviation in the position of the fixing member in the first direction.

[3] In [1] or [2] above, the restricting portion may include a second slide restricting portion configured to restrict movement of the fixing member in a third direction opposite to the first direction by coming into contact with the second part.

According to this configuration, since the movement of the fixing member in the third direction is restricted by the second slide restricting portion coming into contact with the second part of the exterior member in the third direction, it is possible to suppress a significant deviation in the position of the fixing member in the third direction.

[4] In any of [1] to [3] above, the restricting portion may include a rotation restricting portion configured to restrict rotation of the fixing member around a central axis of the first part by coming into contact with the second part.

According to this configuration, since the rotation of the fixing member around the central axis of the first part of the exterior member is restricted by the rotation restricting portion coming into contact with the second part of the exterior member, it is possible to suppress a significant deviation in the orientation of the fixing member.

[5] In [4] above, the rotation restricting portion may include a first rotation restricting portion configured to restrict rotation of the fixing member in a first rotation direction around the central axis by coming into contact with the second part, and a second rotation restricting portion configured to restrict rotation of the fixing member in a second rotation direction opposite to the first rotation direction by coming into contact with the second part.

According to this configuration, since the first rotation restricting portion and the second rotation restricting portion restrict the rotation of the fixing member in both directions around the central axis of the first part, it is possible to further suppress a significant deviation in the orientation of the fixing member.

### Details of Embodiment of Present Disclosure

Specific examples of a wire harness according to aspects of the present disclosure will be described below with reference to the drawings. In the drawings, the configurations may be partially exaggerated or simplified for convenience in the description. Also, the dimensional proportions of various portions may differ among the drawings. The terms “vertical” and “orthogonal” in this specification include not only the case of being strictly vertical or orthogonal, but also the case of being substantially vertical or substantially orthogonal to the extent that actions and effects in the present embodiment are exhibited. The term “cylindrical” used in this specification is not limited to a shape having a continuous peripheral wall formed over the entire periphery in the peripheral direction, but also a cylindrical shape that is formed by combining a plurality of parts or a shape like a C-shape having a cutout portion partially in the peripheral direction. An outer peripheral shape of the “cylindrical” includes, but is not limited to, a circle, an ellipse, and a polygon with sharp or rounded corners. The term “cylindrical” is a shape having a through hole in plan view, and includes one in which the outer peripheral shape thereof is same as or different from an inner peripheral shape of a through hole. The term “cylindrical" includes a shape having a predetermined length extending along an axial direction of a central axis passing through the center of a through hole, and the length does not matter. In addition, the terms “first,” “second,” “third,” and the like in this specification are used simply to distinguish objects, and do not rank the objects. The present disclosure is not limited to the examples herein, but rather is indicated by the scope of claims, and is intended to encompass all modifications within the meaning and the scope equivalent to the scope of claims.

### Configuration of Wire Harness 10

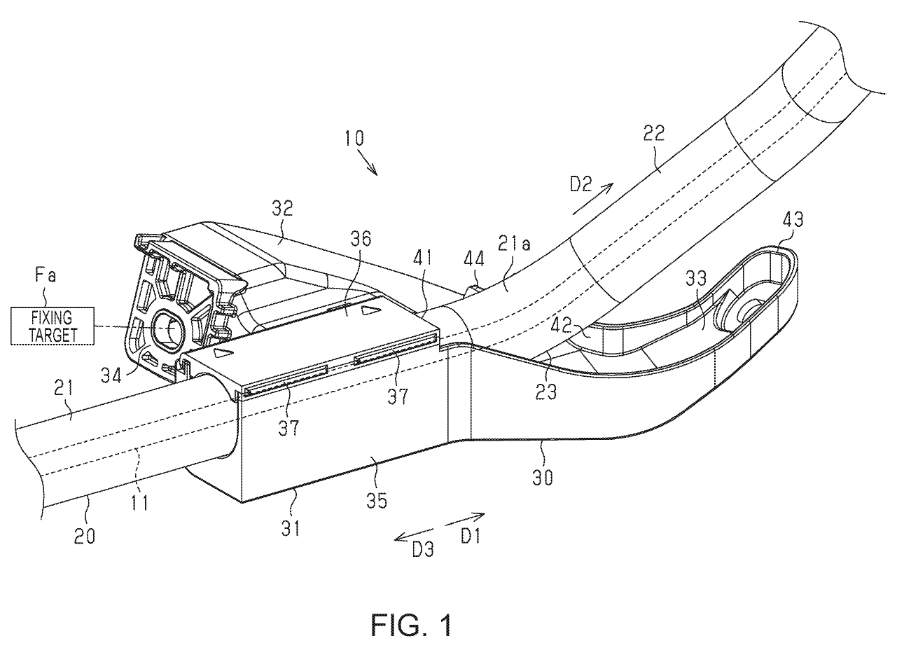

A wire harness 10 shown in FIG. 1 includes an electric wire 11, an exterior member 20 (exterior cover), and a fixing member 30. The wire harness 10 electrically connects two or three or more electrical devices mounted in a vehicle, for example. The wire harness 10 is connected to a high-voltage battery (not shown) mounted in a hybrid vehicle or an electric vehicle, for example. The high-voltage battery is a battery capable of supplying several hundred volts, for example. Also, the wire harness 10 is routed under the floor of the vehicle, for example. The wire harness 10 is fixed to a fixing target Fa, such as a vehicle body panel, with the fixing member 30.

### Configuration of Electric Wire 11

The wire harness 10 includes one or more electric wires 11. The electric wire 11 is a high-voltage electric wire capable of handling a high voltage and a high current, for example. The electric wire 11 is connected to the electrical device via a connector (not shown). The electric wire 11 is, for example, a coated electric wire with an insulation sheath on an outer periphery of a core wire made of a conductor. An outer periphery of the electric wire 11 is covered by the exterior member 20.

### Configuration of Exterior Member 20

The exterior member 20 has an elongated cylindrical shape overall. The exterior member 20 is formed so as to surround the entire outer periphery of the electric wire 11 in most of a length direction in the electric wire 11. In other words, the electric wire 11 is inserted into the exterior member 20. The exterior member 20 is, for example, bent in a two-dimensional or three-dimensional shape along a wiring route of the wire harness 10. The lateral cross-sectional shape of the exterior member 20 is a circular ring shape, for example. Also, the exterior member 20 has a cross-section that is uniform in the length direction, for example. The shape of the outer peripheral surface of the exterior member 20 as viewed from the length direction is approximately a perfect circle. The exterior member 20 is made of a metallic material such as aluminum. The exterior member 20 protects the electric wire 11 from flying debris and water droplets, for example. The exterior member 20 is fixed to the fixing target Fa with the fixing member 30.

The exterior member 20 includes a first part 21 and a second part 22. The first part 21 of the exterior member 20 extends linearly along a first direction D1 as a linear direction. The second part 22 extends from an end 21a in the first direction D1 of the first part 21 along a second direction D2 that intersects the first direction D1. That is, the exterior member 20 includes a bent portion 23 between the first part 21 and the second part 22, where the first part 21 and the second part 22 intersect. In the following description, the central axis along the first direction D1 at the first part 21 of the exterior member 20 is referred to as a central axis L1.

### Configuration of Fixing Member 30

The fixing member 30 is attached to the outer peripheral surface of the exterior member 20. The fixing member 30 is a member used for fixing the exterior member 20 to the fixing target Fa. The fixing member 30 is mainly made of a resin material, for example.

As shown in FIGS. 1, 2, and 3, the fixing member 30 includes an attachment portion 31 (attachment) configured to be attached to the exterior member 20, a first extending portion 32, a second extending portion 33, and a fixing portion 34. In the fixing member 30 according to the present embodiment, the attachment portion 31, the first extending portion 32, the second extending portion 33, and the fixing portion 34 are formed continuously in one piece, for example.

### Configuration of Attachment Portion 31

The attachment portion 31 as a whole has a cylindrical shape that surrounds an outer periphery of the exterior member 20. The attachment portion 31 has an attachment portion body 35 and a lid 36, for example. The lid 36 is formed in one piece with the attachment portion body 35, for example. The attachment portion body 35 and the lid 36 are connected to each other via hinges 37, for example. The attachment portion body 35, the lid 36, and the hinges 37 are formed in one piece. The lid 36 can be rotated about the hinges 37 with respect to the attachment portion body 35.

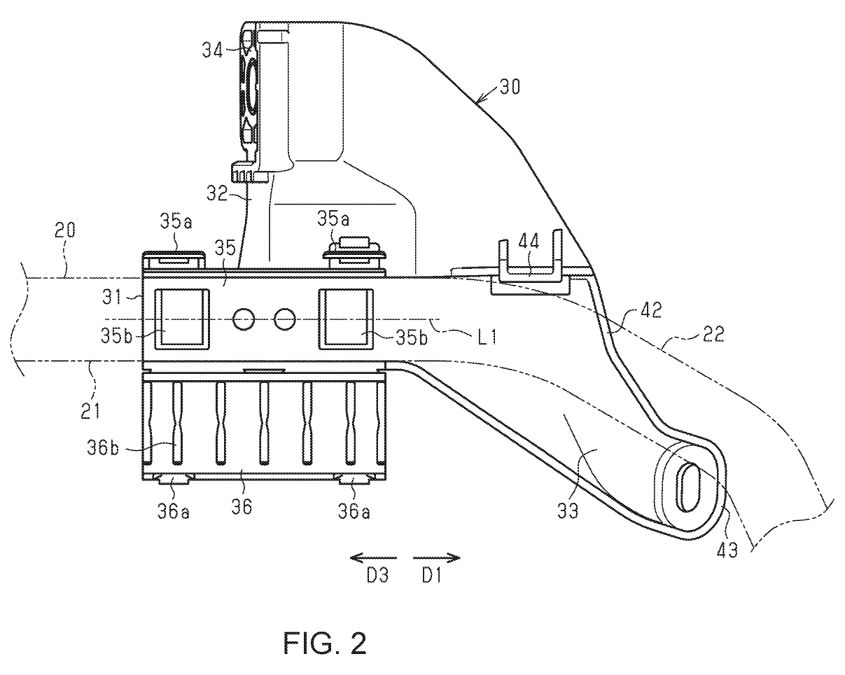

As shown in FIG. 2, the lid 36 has engaging portions 36a that are engaged with locking portions 35a provided on the attachment portion body 35. The lid 36 is held closed due to the engaging portions 36a being engaged with the locking portions 35a. While the lid 36 is closed, the attachment portion 31 is in a cylindrical shape that surrounds and holds an outer periphery of the first part 21 in the exterior member 20.

The lid 36 in the attachment portion 31 includes a plurality of contact projections 36b. Note that FIG. 2 illustrates a state where the lid 36 is opened in the attachment portion 31. The contact projections 36b each protrude from an inner surface of the lid 36 to the inside of the attachment portion 31. The plurality of contact projections 36b are aligned along the first direction D1. The attachment portion body 35 includes elastic pieces 35b. The attachment portion body 35 includes, for example, two elastic pieces 35b. While the lid 36 is closed, the elastic pieces 35b each press the exterior member 20 toward the lid 36. That is, while the lid 36 is closed, the elastic pieces 35b and the contact projections 36b each sandwich the exterior member 20.

### Configuration of First Extending Portion 32 and Fixing Portion 34

The first extending portion 32 of the fixing member 30 extends from the attachment portion body 35 in a direction orthogonal to the central axis L1. The fixing portion 34 is provided on the first extending portion 32. The fixing portion 34 is fixed to the fixing target Fa, for example, by bolts (not shown). Note that the fixing portion 34 may have a metal collar embedded therein, into which the bolts are inserted.

### Configuration of Second Extending Portion 33

The second extending portion 33 of the fixing member 30 extends from the attachment portion body 35, and includes a part that extends along the second direction D2. In the fixing member 30 according to the present embodiment, the second extending portion 33 is, for example, a part for holding a second wire harness, not shown, which is arranged alongside the wire harness 10.

### Configuration of Restricting Portion

The fixing member 30 includes a first slide restricting portion 41, a second slide restricting portion 42, a first rotation restricting portion 43, and a second rotation restricting portion 44. The first slide restricting portion 41, the second slide restricting portion 42, the first rotation restricting portion 43, and the second rotation restricting portion 44 are included in a restricting portion configured to restrict movement of the fixing member 30 by coming into contact with the second part 22 of the exterior member 20. The first rotation restricting portion 43 and the second rotation restricting portion 44 are also included in a rotation restricting portion configured to restrict rotation of the fixing member 30 around the central axis L1 by coming into contact with the second part 22.

### Configuration of First Slide Restricting Portion 41

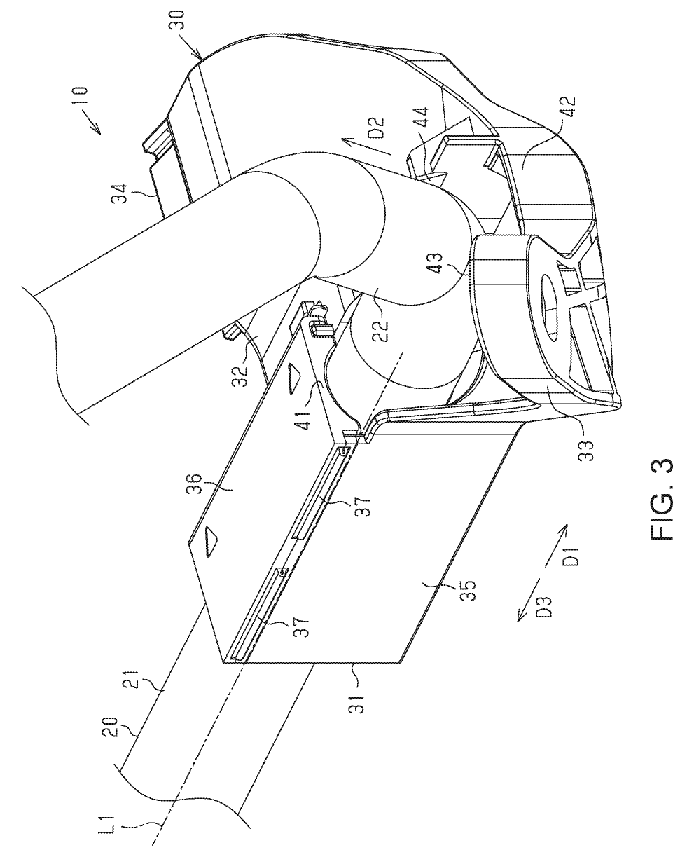

As shown in FIGS. 1 and 3, the first slide restricting portion 41 is configured to be able to come into contact with the second part 22 of the exterior member 20 in the first direction D1 when the fixing member 30 moves in the first direction D1. In the fixing member 30 according to the present embodiment, the first slide restricting portion 41 is, for example, an end in the first direction D1 of the lid 36 in the attachment portion 31. The first slide restricting portion 41 restricts movement of the fixing member 30 in the first direction D1 by coming into contact with the second part 22.

Configuration of Second Slide Restricting Portion 42

The second slide restricting portion 42 is configured to be able to come into contact with the second part 22 of the exterior member 20 in a third direction D3 when the fixing member 30 moves in the third direction D3. In the fixing member 30 according to the present embodiment, the second slide restricting portion 42 is, for example, a wall portion erected from an edge of the second extending portion 33. The second slide restricting portion 42 restricts movement of the fixing member 30 in the third direction D3 by coming into contact with the second part 22.

### Configuration of First Rotation Restricting Portion 43

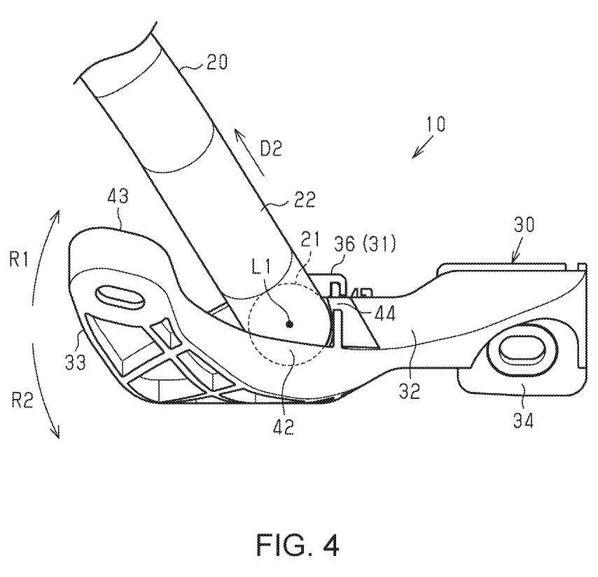

As shown in FIG. 4, the first rotation restricting portion 43 is configured to be able to come into contact with the second part 22 of the exterior member 20 in a first rotation direction R1 when the attachment portion 31 of the fixing member 30 rotates around the central axis L1 in the first rotation direction R1. In the fixing member 30 according to the present embodiment, the first rotation restricting portion 43 is, for example, a wall portion erected from a front end of the second extending portion 33. The first rotation restricting portion 43 restricts rotation of the fixing member 30 around the central axis L1 in the first rotation direction R1 by coming into contact with the second part 22.

### Configuration of Second Rotation Restricting Portion 44

The second rotation restricting portion 44 is configured to be able to come into contact with the second part 22 of the exterior member 20 in a second rotation direction R2 opposite to the first rotation direction R1 when the attachment portion 31 of the fixing member 30 rotates around the central axis L1 in the second rotation direction R2. In the fixing member 30 according to the present embodiment, the second rotation restricting portion 44 is, for example, a wall portion standing upright from the second extending portion 33. The second rotation restricting portion 44 restricts rotation of the fixing member 30 around the central axis L1 in the second rotation direction R2 by coming into contact with the second part 22.

### Operation of Present Embodiment

The following describes operations of the present embodiment.

The first slide restricting portion 41, the second slide restricting portion 42, the first rotation restricting portion 43, and the second rotation restricting portion 44 come into contact with the second part 22 of the exterior member 20, whereby movement of the fixing member 30 is restricted.

The fixing member 30 is movable in the first direction D1 in a section until the first slide restricting portion 41 comes into contact with the second part 22 of the exterior member 20. Moreover, the fixing member 30 is movable in the third direction D3 in a section until the second slide restricting portion 42 comes into contact with the second part 22 of the exterior member 20. This allows slight movement of the fixing member 30 in the direction along the central axis L1 (first direction D1 and third direction D3), thereby absorbing a positional tolerance between the fixing member 30 and the fixing target Fa in the direction along the central axis L1.

Moreover, the fixing member 30 is rotatable in the first rotation direction R1 in a section until the first rotation restricting portion 43 comes into contact with the second part 22 of the exterior member 20. Moreover, the fixing member 30 is rotatable in the second rotation direction R2 in a section until the second rotation restricting portion 44 comes into contact with the second part 22 of the exterior member 20. This allows slight rotation of the fixing member 30 around the central axis L1, thereby absorbing a positional tolerance (angular tolerance with respect to the central axis L1) between the fixing member 30 and the fixing target Fa.

### Effects of Embodiment

### The following describes effects of the present embodiment.

(1) The fixing member 30 includes the restricting portion (first slide restricting portion 41, second slide restricting portion 42, first rotation restricting portion 43, and second rotation restricting portion 44) configured to restrict movement of the fixing member 30 by coming into contact with the second part 22. According to this configuration, since the movement of the fixing member 30 is restricted by the restricting portion coming into contact with the second part 22 of the exterior member 20, it is possible to suppress a significant deviation in the position and orientation of the fixing member 30. As a result, assemblability is improved when the fixing member 30 is assembled to the fixing target Fa.

(2) The restricting portion includes the first slide restricting portion 41 configured to restrict movement of the fixing member 30 in the first direction D1 by coming into contact with the second part 22 of the exterior member 20. According to this configuration, since the movement of the fixing member 30 in the first direction D1 is restricted by the first slide restricting portion 41 coming into contact with the second part 22 of the exterior member 20 in the first direction D1, it is possible to suppress a significant deviation in the position of the fixing member 30 in the first direction D1.

(3) The restricting portion includes the second slide restricting portion 42 configured to restrict movement of the fixing member 30 in the third direction D3 opposite to the first direction D1 by coming into contact with the second part 22 of the exterior member 20. According to this configuration, since the movement of the fixing member 30 in the third direction D3 is restricted by the second slide restricting portion 42 coming into contact with the second part 22 of the exterior member 20 in the third direction D3, it is possible to suppress a significant deviation in the position of the fixing member 30 in the third direction D3.

(4) The restricting portion includes the rotation restricting portion (first rotation restricting portion 43 and second rotation restricting portion 44) configured to restrict the rotation of the fixing member 30 around the central axis L1 of the first part 21 by coming into contact with the second part 22 of the exterior member 20. According to this configuration, since the rotation of the fixing member 30 around the central axis L1 of the first part 21 of the exterior member 20 is restricted by the rotation restricting portion coming into contact with the second part 22 of the exterior member 20, it is possible to suppress a significant deviation in the orientation of the fixing member 30.

(5) The rotation restricting portion includes the first rotation restricting portion 43 configured to restrict the rotation of the fixing member 30 around the central axis L1 in the first rotation direction R1 by coming into contact with the second part 22 of the exterior member 20, and the second rotation restricting portion 44 configured to restrict the rotation of the fixing member 30 in the second rotation direction R2 opposite to the first rotation direction R1 by coming into contact with the second part 22 of the exterior member 20. According to this configuration, since the first rotation restricting portion 43 and the second rotation restricting portion 44 restrict the rotation of the fixing member 30 in both directions around the central axis L1 of the first part 21, it is possible to further suppress a significant deviation in the orientation of the fixing member 30.

### Other Embodiments

The embodiment described above can be modified as follows. The embodiment described above and following modifications may be combined with each other to the extent that no technical discrepancy occurs.

The configurations of the first slide restricting portion 41, the second slide restricting portion 42, the first rotation restricting portion 43, and the second rotation restricting portion 44 are not limited to the above embodiment, but may be appropriately changed according to the configuration of the exterior member 20.

In the fixing member 30, one, two, or three of the first slide restricting portion 41, the second slide restricting portion 42, the first rotation restricting portion 43, and the second rotation restricting portion 44 may be omitted.

The exterior member 20 may be made of a material other than metal, such as resin.

The shape of the attachment portion 31 in the embodiment described above is not particularly limited. The shape of the attachment portion 31 is not particularly limited as long as it can hold the exterior member 20.

In the attachment portion 31 of the fixing member 30, the lid 36 may be separate from the attachment portion body 35.

The electric wire 11 inserted into the exterior member 20 may be, for example, a low-voltage electric wire that connects a low-voltage battery and various low-voltage devices (e.g., lamp and car audio device).

The embodiments disclosed this time should be considered illustrative in all aspects, and the present disclosure is not limited to the examples herein. That is, the scope of the present disclosure is indicated by the scope of claims, and is intended to encompass all modifications within the meaning and the scope equivalent to the scope of claims.

What is claimed is:

1. A wire harness, comprising:
an electric wire;
a cylindrical exterior cover that is configured to cover an outer periphery of the electric wire; and
a fixing member that is configured to fix the exterior cover to a fixing target, wherein:
the exterior cover includes:
a first part extending linearly along a first direction; and
a second part extending in a second direction that intersects the first direction from an end in the first direction of the first part, and
the fixing member includes:
an attachment that is configured to be attached to the first part so as to cover an outer periphery of the first part;
a fixing portion that is configured to be fixed to the fixing target; and
a restricting portion that is configured to be able to come into contact with the second part and to restrict movement of the fixing member by coming into contact with the second part.

2. The wire harness according to claim 1, wherein
the restricting portion includes a slide restricting portion that is configured to restrict movement of the fixing member in the first direction by coming into contact with the second part.

3. The wire harness according to claim 1, wherein
the restricting portion includes a slide restricting portion that is configured to restrict movement of the fixing member in a third direction opposite to the first direction by coming into contact with the second part.

4. The wire harness according to claim 1, wherein
the restricting portion includes a rotation restricting portion that is configured to restrict rotation of the fixing member around a central axis of the first part by coming into contact with the second part.

5. The wire harness according to claim 4, further comprising:
a first rotation restricting portion and a second rotation restricting portion with the rotation restricting portion being one of the first rotation restricting portion and the second rotation restricting portion,
wherein the first rotation restricting portion that is configured to restrict rotation of the fixing member in a first rotation direction around the central axis by coming into contact with the second part, and the second rotation restricting portion that is configured to restrict rotation of the fixing member in a second rotation direction opposite to the first rotation direction by coming into contact with the second part.
